(19) United States
(12) Patent Application Publication
(10) Pub. No.: US 2008/0168654 A1
(43) Pub. Date: Jul. 17, 2008

(54) HYDRODYNAMIC BEARING AND METHOD FOR MANUFACTURING THE SAME

(75) Inventor: CHUEN-SHU HOU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Tu-Cheng (TW)

(21) Appl. No.: 11/687,205

(22) Filed: Mar. 16, 2007

(30) Foreign Application Priority Data
Jan. 17, 2007 (CN) 200710072864.4

(51) Int. Cl. B21K 1/10; F16C 32/06

(52) U.S. Cl. 29/898.02; 384/123

(57) ABSTRACT

A hydrodynamic bearing has a plurality of grooves (34) defined therein. The grooves are used for generating hydrodynamic pressure. Each of the grooves includes an upper branch (344) and a lower branch (342) coupled to the upper branch. The upper branch has a larger angle (β1) of divergence from the groove than that (β2) of the lower branch.

### CROSS-REFERENCES TO RELATED APPLICATION

This application is related to U.S. patent application Ser. No. 11/627,566 filed on Jan. 26, 2007 and entitled “METHOD FOR MANUFACTURING HYDRODYNAMIC BEARING AND SHAFT”; the co-pending U.S. patent application is assigned to the same assignee as the instant application. The disclosure of the above-identified application is incorporated herein by reference.

### BACKGROUND OF THE INVENTION

1. Field of the Invention

The present invention relates generally to a bearing and a shaft, and more particularly to a bearing or a shaft with hydrodynamic pressure generating grooves.

2. Description of Related Art

At present, hydrodynamic bearings are widely used in spindle motors in devices, such as compact disc (CD) drivers, digital video disc (DVD) drivers, hard disk drivers, laser beam printers, floppy disk drivers or in heat-dissipation fans. Spindle motors require a hydrodynamic bearing of small size, high rotational accuracy and long life.

A typical hydrodynamic bearing defines a bearing hole therein. A shaft is rotatably received in the bearing hole. A plurality of herringbone-shaped grooves (i.e., branching off from a central axis) are defined either in an inner circumferential surface of the bearing or in an external circumferential surface of the shaft. The grooves can accommodate lubricant, such as oil. During rotation of the shaft, the lubricant is driven by the rotating shaft. A lubricating film is thus formed in a clearance between the external circumferential surface of the shaft and the inner circumferential surface of the bearing. Accordingly, the shaft is supported by hydrodynamic shearing stress and dynamic pressure generated by the lubricating film when the lubricant flows through different cross-sections. Referring to FIG. 8, a hydrodynamic bearing 400 has a plurality of herringbone-shaped grooves 440 defined in an inner circumferential surface thereof. Each of the grooves 440 includes two branches 442 at two opposing sides. A portion of the lubricant flows along direction OX, meanwhile, another portion of the lubricant flows along direction OY. A large and complicated hydrodynamic pressure or pumping action between the bearing 400 and a shaft (not shown) results in dynamic imbalance between a lubricant flow shown by arrows 50 and another lubricant flow shown by arrows 50. Accordingly, a portion of the lubricant may flow from ends of the bearing 400 and leak out.

A related method for manufacturing the hydrodynamic bearing 400 comprises following processes of: (a1) manufacturing a bearing preform with a bearing hole therein; and (a2) defining a plurality of hydrodynamic pressure generating grooves 440 in a bearing surface 450 of the bearing preform by chemical etching, electrolysis electric discharge or machining. However, the small size of the hydrodynamic bearing 400 results in difficulties particularly in the making of the grooves 440 in the bearing surface 450 of the bearing preform. This makes manufacturing of the hydrodynamic bearing 400 both time-consuming and expensive. Therefore, the related method is not suitable for mass-production of the hydrodynamic bearing 400.

It is therefore desirable to provide an improved method for mass production of a hydrodynamic bearing which can provide a good lubricant-conservation function.

### SUMMARY OF THE INVENTION

A hydrodynamic bearing has a plurality of grooves defined therein. The grooves are used for generating hydrodynamic pressure. Each of the grooves includes an upper branch and a lower branch coupled to the upper branch. The upper branch has a larger angle of divergence from the groove than that of the lower branch.

Other advantages and novel features of the present invention will become more apparent from the following detailed description of preferred embodiment when taken in conjunction with the accompanying drawings.

### BRIEF DESCRIPTION OF THE DRAWINGS

Many aspects of the present driving device can be better understood with reference to the following drawings. The components in the drawings are not necessarily drawn to scale, the emphasis instead being placed upon clearly illustrating the principles of the present driving device. Moreover, in the drawings, like reference numerals designate corresponding parts throughout the several views.

FIG. 1 is an expanded view of a hydrodynamic bearing along a circumferential direction thereof in accordance with a preferred embodiment of the present invention;

FIG. 2 is an expanded view of a row of herringbone-shaped grooves adjacent to an upside of the bearing of FIG. 1;

FIG. 3 is an expanded view of another row of herringbone-shaped grooves adjacent to a downside of the bearing of FIG. 1;

FIG. 4 is a flow chart of a method employed in manufacturing a hydrodynamic bearing in accordance with a preferred embodiment of the present invention;

FIG. 5 is an isometric view of a substrate formed by the method in FIG. 4;

FIG. 6 is an isometric view of the substrate of FIG. 4 surrounded by a bearing preform;

FIG. 7 is a cross-sectional, isometric view of a hydrodynamic bearing obtained by the method of FIG. 4; and

FIG. 8 is an expanded view along a circumferential direction of a related hydrodynamic bearing.

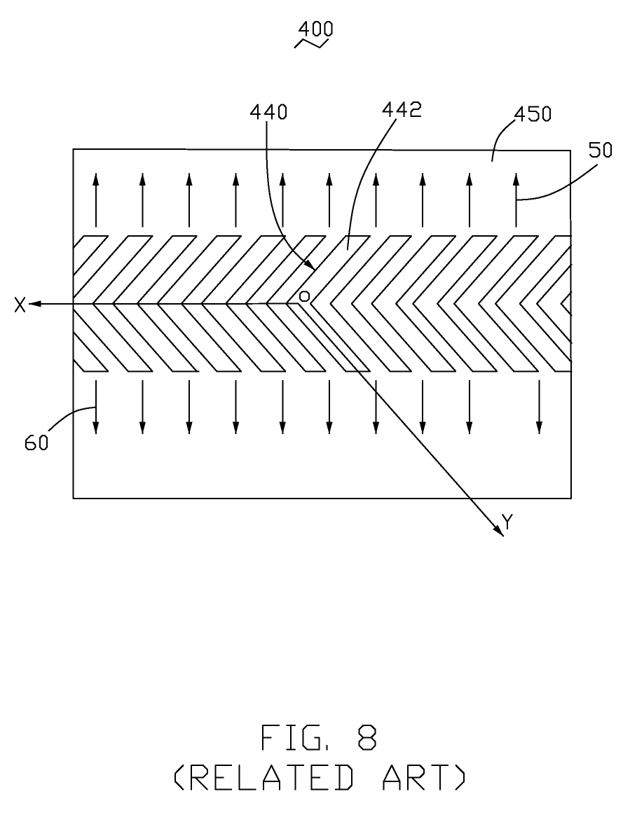

### DETAILED DESCRIPTION OF THE INVENTION

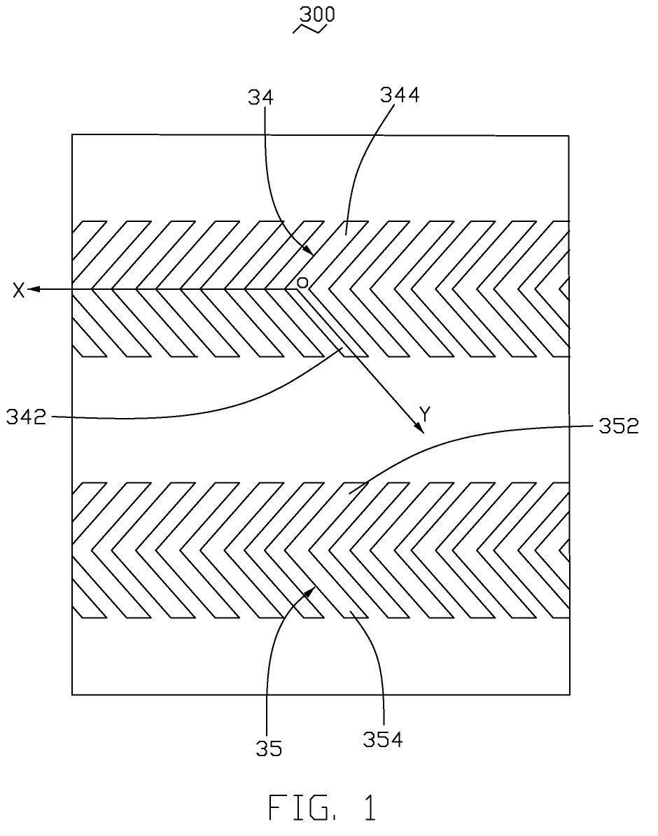

Referring to FIG. 1, a hydrodynamic bearing 300 in accordance with a preferred embodiment of the present invention is shown. The hydrodynamic bearing 300 has two rows of a plurality of herringbone-shaped grooves 34, 35 with less lubricant leakage that can provide a large hydrodynamic pressure to support a shaft that is adapted to be engaged in the hydrodynamic bearing 300. The two rows of grooves 34, 35 are spaced from each other and arranged in a circumferential direction of the hydrodynamic bearing 300. Each of the grooves 34 includes two branches 342,344 configured at two sides thereof respectively. Each of the grooves 35 can be V shaped, and includes two branches 352, 354. An extension direction of each of the branches 342, 344, 352, 354 shown as direction OY deviates from a circumferential direction of the hydrodynamic bearing 300 shown as direction OX. Each of the branches 342, 344, 352, 354 has an angle. The angle is an acute angle between the OY direction and the OX direction.

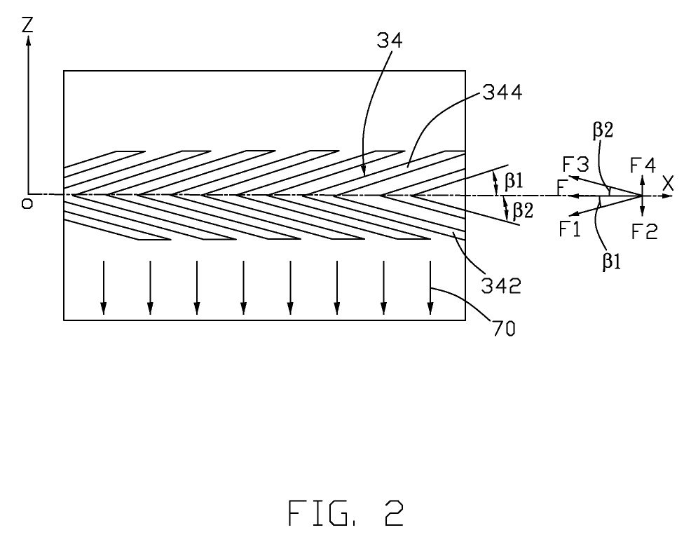

Referring to FIG. 2, forces created by the lubricant in the branches 342, 344 are analyzed in following details. Each branch 344 forms an angle β1 to line X. Each branch 342 forms an angle β2 to line X. Two forces F1, F3 are caused by the lubricant along the extension directions of the branch 344, 342 respectively when the shaft rotates. A force F is caused by the force F1 or the force F3 along a circumferential direction of the hydrodynamic bearing 300. The force F1 and the force F3 are also tangential forces along an inner circumferential surface of the hydrodynamic bearing 300.

Two conditions are presumed:
1) no deformation of the shaft;
2) velocities along a circumferential and tangent direction of any point of the surface of the shaft are of same value.
According to the two conditions above, the relationships between the forces F1, F and F3 are shown below:

F1×Cos β1=F=F3×Cos β2 (1)

The angles β1, β2 meet a condition of 90°>β1>β2>0°, thus

Cos β1<Cos β2 (2)

So according to the equations of (1) and (2), the relationship between the forces F1, F3 is as below:

F1>F3 (3)

Furthermore, the forces F2, F4 are assumed as forces caused by the forces F1, F3 along two axial directions (shown as ZO and OZ directions) of the bearing 300 respectively, where:

F2=F1×Sin β1, F4=F3×Sin β2 (4)

and 90°>β1>β2>0°, thus

Sin β1>Sin β2 (5)

So according to the equations (3), (4) and (5), the relationship between the F2 and F4 is as below:

F2>F4 (6)

According to the equation (6), when the angles β1,β2 meet the condition of 90°>β1>β2>0°, the force F2 (shown as the ZO direction) of the branch 344 on an upper side of the groove 34 is larger than the force F4 (shown as the OZ direction) of the branch 342 on a lower side of the groove 34. Accordingly, the lubricant of the grooves 34 is inclined to flow into the lower side (shown by arrows 70) where the branches 342 having the smaller angle β2 are located. Thus, the lubricant can be prevented from flowing to the upper side adjacent to the branch 344 of the groove 34.

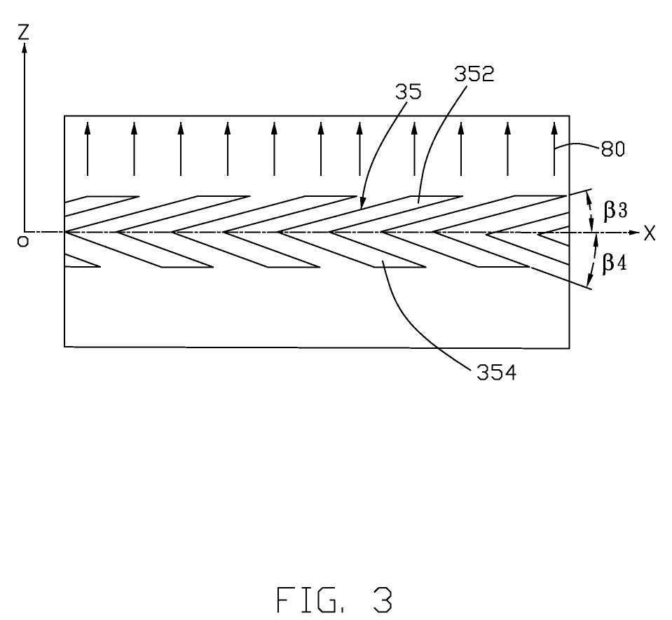

Referring to FIG. 3, an angle β4 is formed between each branch 352 of the grooves 35 and line X. An angle β3 is the angle of each branch 354 of the grooves 35 to line X. When the angle β4 is larger than the angle β3, the lubricant of the grooves 35 is inclined to flow towards the side (shown as arrows 80) where the branches 352 are located in order to prevent the lubricant from flowing towards the branches 354. Overall, the angles β2, β3 of the branches 342, 352 located at inner sides of the two rows are respectively smaller than the angles β1, β4 of the branches 344, 354 located at external sides of the two rows. As described above, the lubricant can be kept in an area between the grooves 34 and the grooves 35 in the hydrodynamic bearing 300. Thus, the hydrodynamic bearing 300 with the grooves 34, 35 retains the lubricant well and has a long operating life.

In a second embodiment of the present invention, there is only one row of grooves 34 formed in the bearing 300, which has an open side and a closed side. The branches 342 of the grooves 34 with the smaller angles β2 can be arranged near the closed side of the hydrodynamic bearing 300, while the branches 344 with the larger angles β1 are positioned near the open side of the hydrodynamic bearing device. Thus, the lubricant can be kept in areas around the closed side of the bearing 300. It is noted that, in theory, the force F2 should be equal to the force F4 when the angle β1 is equal to the angle β2. However, in fact, because of pumping and magnetic suspension action caused by the herringbone-shaped grooves 34, 35, the force F4 is often larger than the force F2 so that the lubricant is driven to flow along the OZ direction, and then leaks out. Accordingly, the shaft rotates unsteadily due to lack of the lubricant. In the hydrodynamic bearing 300 in the preferred embodiment of the present invention, the pumping and magnetic suspension problem can be solved as the angle β1 is constructed larger than the angle β2. Thus, a dynamic balance of the lubricant near the grooves 34 can be achieved.

A plurality of herringbone-shaped grooves 34, 35 configured by the branches 342, 344, 352, 354 can also been defined in the shaft in a hydrodynamic bearing device (not shown). The shaft configured by the branches 342, 344, 352, 354 can also been used to avoid leakage of the lubricant.

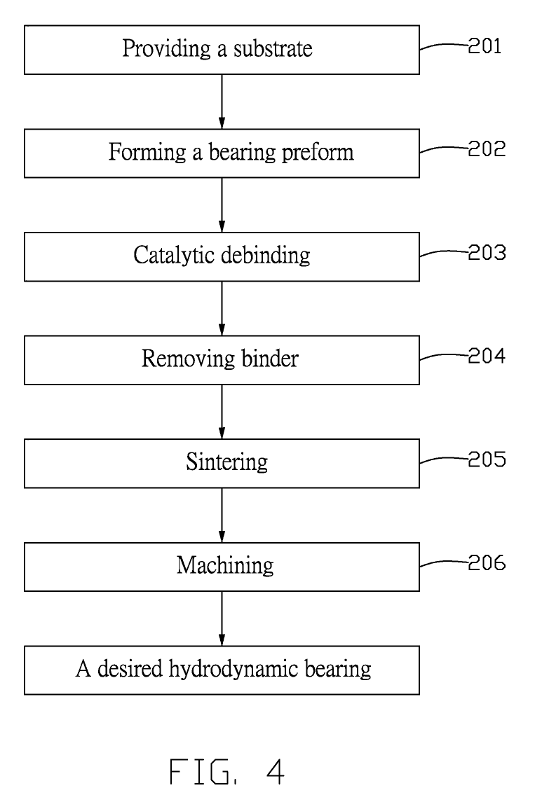

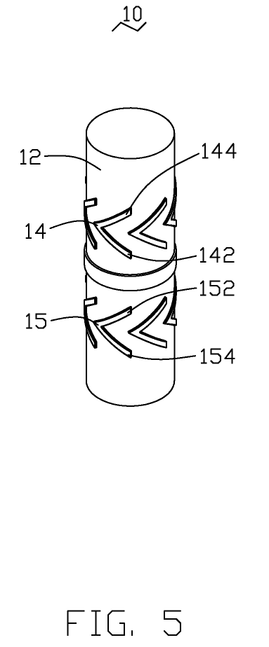

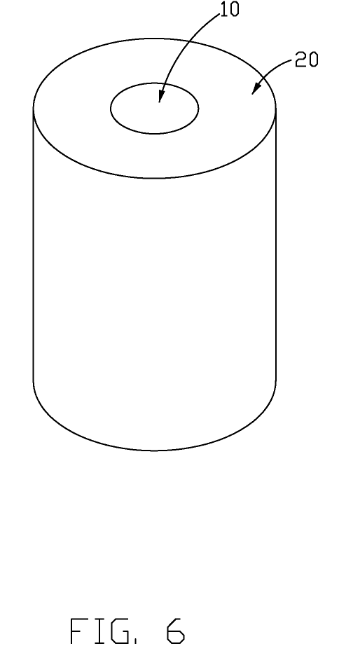

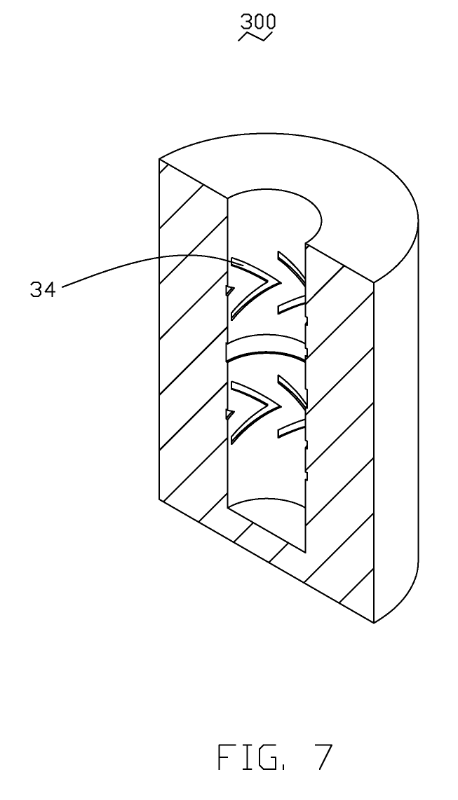

As shown in FIGS. 4-7, a method for manufacturing the hydrodynamic bearing 300 configured by the grooves 34, 35 in accordance with the present invention, comprises the steps of:

step 201: providing a substrate 10 with a plurality of protrusions 1 4, 15 formed on a periphery thereof;
step 202: placing the substrate 10 in a middle of a hollow mold, then injecting a feedstock of powder and molten binder into the mold to surround the substrate 10 under pressure, thus forming a desired bearing preform 20;
step 203: separating the substrate 10 from the bearing preform 20 by means of catalytic debinding;
step 204: separating the binder from the bearing preform 20;
step 205: sintering the bearing preform 20; and
step 206: performing a precision machining to the bearing preform 20, thereby forming the desired hydrodynamic bearing 300.

The substrate 10 should be configured according to the grooves 34, 35 of the hydrodynamic bearing 300 as an external periphery of the substrate 10 corresponding to an inner surface of the desired hydrodynamic bearing 300. The substrate 10 comprises a cylindrical body 12 and a plurality of herringbone-shaped protrusions 14, 15 formed on a circumferential surface of the body 12. The body 12 is used for forming a bearing hole of the hydrodynamic bearing 300 and the protrusions 14, 15 are used to form the herringbone-shaped grooves 34, 35 of the hydrodynamic bearing 300. Each of the protrusions 14, 15 includes two branches 142, 144 and 152, 154 respectively. Angles of the branches 144, 154 to line X are required to be larger than those of the branches 142, 152 to line X respectively.

Step 201 is described in detail as follows: a material for forming the substrate 10 should meet requirements for steps 202 and step 203. In step 202, a melting point of the material for forming the substrate 10 is required to be higher than that of the molten binder of the feedstock to prevent the substrate 10 from being deformed when the substrate 10 contacts with the feedstock. On the other hand, in step 203, the material for forming the substrate 10 should be easily separable from the hydrodynamic bearing preform 20 by means of debinding. For example, polyoxymethylene (POM) can be used as a material for the substrate 10. POM has many advantages such as excellent mechanical properties (i.e. rigidity, impact resistant, low abrasion, creep resistance), outstanding chemical properties (i.e. hydrolytic stability fatigue endurance and solvent resistance) and good thermal stability. The substrate 10 composed of POM can be made by means of injection molding, extrusion molding, blow molding, rotational molding, soldering, adhering, coating, plating, machining and so on. Injection molding can be used for making the desired substrate 10 and has steps including: (c1) melting the material for forming the substrate 10; (c2) injecting the molten material into a mold (not shown) to form the substrate 10; (c3) cooling the mold and taking the substrate 10 out of the mold. Injection molding can be performed in a normal injection machine. The material for forming the substrate 10 further comprises dispersant, surfactant and additive.

Step 202 is described in detail as follows: the hydrodynamic bearing preform 20 can be formed by metal injection molding (MIM) when the substrate 10 is mainly composed of POM. The feedstock generally comprises metal powder or ceramic powder. The binder of the feedstock is required to be a material with a lower melting point than that of the substrate 10 and to be easily removable by debinding or extraction, such as polyethylene (PE). MIM includes the following processes: (d1) mixing the powder and the binder to form the feedstock under a high temperature; (d2) pushing the feedstock to form a desired shape such as the hydrodynamic bearing preform 20 in a mold under pressure. Injection machine used in step 201 for forming the substrate 10 can be used to manufacture the hydrodynamic bearing preform 20 in step 202. MIM used for manufacturing the hydrodynamic bearing preform 20 has many advantages such as high shape complexity, low cost, tight tolerances, high density, high performance etc.

Step 203 is described in detail as follows: debinding methods available include thermal cracking debinding and catalytic debinding. Catalytic debinding is used to separate the substrate 10 from the hydrodynamic bearing preform 20 in accordance with a preferred embodiment of the present invention. Catalytic debinding comprises following processes: (e1) placing the hydrodynamic bearing preform 20 made by step 202 in a central area of a furnace for debinding; (e2) Inputting nitric acid (HNO₃) gas as a catalyst into the furnace at a temperature in an approximate range of between 110° C. and 140° C. that is lower than a melting point of the hydrodynamic bearing preform 20. POM reacts with HNO₃ and decomposes to form gaseous formaldehyde in the acid and thermal atmosphere so that the substrate 10 can be quickly removed from the hydrodynamic bearing preform 20. Applying catalytic cracking debinding to remove the substrate 10 costs much less time than applying thermal cracking debinding. Thus the rate of debinding is increased and the hydrodynamic bearing preform 20 is given good shape retention by means of catalytic debinding; however, during the thermal cracking debinding process, the hydrodynamic bearing preform 20 is inclined to break during the thermal cracking debinding process because of the difference between a coefficient of expansion of the substrate 10 and that of the hydrodynamic bearing preform 20. Accordingly, catalytic cracking debinding is preferred to thermal cracking debinding in the present invention. In spite of this, thermal cracking debinding still can be used to achieve debinding of the substrate 10 if the heating process thereof is precisely controlled. Furthermore, the gaseous formaldehyde produced during the catalytic debinding process is transferred to another part of the furnace to burn into carbon dioxide (CO₂) and nitrogen dioxide (NO₂), which are not toxic. As a result, the bearing 300 has accurate size and concentricity.

Step 204 is described in detail as follows: after the substrate 10 is separated from the bearing preform 20, the binder can be removed from the bearing preform 20 by means of thermal debinding or extraction.

Step 205 is described in detail as follows: after the binder is separated from the bearing preform 20, the bearing preform 20 consequently is weaken. Therefore, it is necessary to sinter the bearing preform 20 in place. The sintering process can be performed in a vacuum, or in an oxygen and/or nitrogen atmosphere.

Step 206 is described in detail as follows: generally, the hydrodynamic bearing preform 20 is inclined to deform during the sintering processes. In order to make a hydrodynamic bearing preform 20 having a high level of precision in its manufacture, it is necessary to perform a machining operation on the bearing preform 20 using methods such as broaching, grinding, milling, polishing, and so on.

Furthermore, the method in accordance with the preferred embodiment of the present invention can be used for manufacturing other kinds of hydrodynamic bearings or shaft with different shapes of grooves. When applying the method to make a desired shaft with hydrodynamic pressure generating grooves formed in a circumferential surface thereof, a substrate with a central hole defined therein should be provided. An internal surface of the substrate is required to correspond in shape to the circumferential surface of the desired shaft.

Compared with the related method for manufacturing the hydrodynamic bearing 400, the hydrodynamic bearing 300 is configured (i.e., structured and arranged) for mass-production by the method in accordance with the preferred embodiment of the present invention. Also, the hydrodynamic bearing 300 manufactured by the present method has good lubricant retention.

It is to be understood that the above-described methods are intended to illustrate rather than limit the invention. Variations may be made to the methods without departing from the spirit of the invention. Accordingly, it is appropriate that the appended claims be construed broadly and in a manner consistent with the scope of the invention.

What is claimed is:

1. A hydrodynamic bearing having a bearing surface adapted for receiving a shaft to rotate thereon, the bearing surface having a plurality of grooves defined therein, the grooves for generating hydrodynamic pressure, each of the grooves comprising an upper branch and a lower branch coupled to the upper branch, the upper branch having a larger angle of divergence from the each of the grooves than that of the lower branch.

2. The hydrodynamic bearing as claimed in claim 1, wherein the grooves of the hydrodynamic bearing are herringbone-shaped.

3. The hydrodynamic bearing as claimed in claim 2, wherein an extension direction of each of the two branches deviates from a circumference of the hydrodynamic bearing.

4. The hydrodynamic bearing as claimed in claim 1, wherein the branch having the smaller angle of divergence from the groove is near a closed side of a hydrodynamic bearing, while the branch with the larger angle is near an open side of the hydrodynamic bearing.

5. The hydrodynamic bearing as claimed in claim 2, wherein the hydrodynamic bearing comprises two rows of the herringbone-shaped grooves, the divergence angles of the branches located at inner sides of the two rows are smaller than the divergence angles of the branches located on external sides of the two rows respectively.

6. A method for manufacturing a hydrodynamic bearing with hydrodynamic pressure generating grooves comprising:
providing a substrate with a plurality of protrusions formed on a periphery thereof, each of the protrusions comprising an upper branch and a lower branch coupled to the upper branch, the upper branch having a larger angle of divergence from the groove than that of the lower branch;
placing the substrate in a middle of a hollow mold, then injecting a feedstock of powder and molten binder into the mold to surround the substrate under pressure, thus forming a desired bearing preform;
separating the substrate from the bearing preform by means of catalytic debinding;
separating the molten binder from the bearing preform; and
sintering the bearing preform to thereby form the hydrodynamic bearing.

7. The method as claimed in claim 6, wherein polyoxymethylene (POM) is provided as a material of the substrate.

8. The method as claimed in claim 7, wherein the substrate is made using a method chosen from a group of consisting of injection molding, extrusion molding, blow molding, rotational molding, soldering, adhering, coating, plating or machining.

9. The method as claimed in claim 6, wherein in the catalytic debinding, nitric acid (HNO₃) gas is used as a catalyst.

10. The method as claimed in claim 9, wherein in the catalytic debinding, a temperature in a furnace for debinding is maintained in an approximate range of 110° C. to 140° C.

11. The method as claimed in claim 9, wherein gaseous formaldehyde produced during the catalytic debinding process is transferred to burn into carbon dioxide (CO₂) and nitrogen dioxide (NO₂).

12. The method as claimed in claim 6, wherein polyethylene (PE) is used as a material of the binder of the feedstock.

13. The method as claimed in claim 12, wherein the binder of the feedstock is removed by debinding or extraction.

14. The method as claimed in claim 6, wherein a precision machining operation is performed on the bearing preform after the sintering process.

15. A cylinder-shaped bearing device having a circular bearing surface adapted for receiving a rotating member to rotate thereon, the bearing surface having a row of herringbone-shaped grooves extending along a circumferential direction thereof, wherein each of the grooves has an upper branch angled from the circumferential direction a first acute angle and a lower branch angled from the circumferential direction a second acute angle, the first acute angle being different from the second acute angle.

16. The bearing device as claimed in claim 15, wherein the bearing device has a closed end and an opened end, the lower branch being located near the closed end and the first acute angle being larger than the second acute angle.

17. The bearing device as claimed in claim 15, wherein the bearing surface has another row of herringbone-shaped grooves extending along the circumferential direction thereof, the another row of herringbone-shaped grooves each having an upper branch angled from the circumferential direction a third acute angle and a lower branch angled from the circumferential direction a fourth acute angle, the third acute angle being different from the fourth acute angle.

18. The bearing device as claimed in claim 17, wherein the another row of grooves is located below the row of grooves, and the first acute angle is larger than the second acute angle while the fourth acute angle is larger than the third acute angle.
